(19) United States
(12) Patent Application Publication
(10) Pub. No.: US 2023/0394652 A1
(43) Pub. Date: Dec. 7, 2023

(54) SEQUENTIAL OUT OF DISTRIBUTION DETECTION FOR MEDICAL IMAGING

(71) Applicant: KONINKLIJKE PHILIPS N.V., Eindhoven (NL)

(72) Inventors: Nicola Pezzotti, Eindhoven (NL); Christian Wuelker, Hamburg (DE); Tim Nielsen, Hamburg (DE); Karsten Sommer, Hamburg (DE); Michael Grass, Buchholz in der Nordheide (DE); Heinrich Schulz, Hamburg (DE); Sergey Kastryulin, Moscow (RU)

(21) Appl. No.: 18/031,889

(22) PCT Filed: Oct. 11, 2021
(86) PCT No.: PCT/EP2021/077973

§ 371 Date: Apr. 14, 2023

(30) Foreign Application Priority Data
Oct. 16, 2020 (RU) 2020134071

(51) Int. Cl. G06T 7/00

(52) U.S. Cl. CPC G06T 7/0012; G06T 2207/20084; G06T 2207/20081

(57) ABSTRACT

Disclosed herein is a medical system (100, 300, 400) comprising a memory (110) storing a trainable machine learning module (122) trained using training data descriptive of a training data distribution (600) to output a reconstructed medical image (136) in response to receiving measured medical image data (128) as input. The medical system comprises a computational system (104). The execution of machine executable instructions (120) causes the computational system to: receive (200) the measured medical image data and determine (202) the out-of-distribution score and the in-distribution accuracy score consecutively in an order determined a sequence, detect (204) a rejection of the measured medical image data using the out-of-distribution score and/or the in-distribution accuracy score during execution of the sequence, provide (206) a warning signal (134) if the rejection of the measured medical image data is detected. The out-of-distribution score is determined by inputting the measured medical image data into the out-of-distribution estimation module. The in-distribution accuracy score is determined by inputting the measured medical image data into the in-distribution accuracy estimation module.

### FIELD OF THE INVENTION

The invention relates to medical imaging, in particular to medical imaging techniques that use machine learning for image reconstruction or enhancement.

### BACKGROUND OF THE INVENTION

Medical images descriptive of a subject's anatomy can be generated using a variety of different techniques. Common imaging modalities include magnetic resonance imaging, computed tomography, positron emission tomography, ultrasound, and others. Artificial intelligence techniques may be used for such tasks as image reconstruction, the removal of artifacts, denoising, and other image processing tasks.

International patent application WO2020025696A1 discloses a method of generating augmented images of tissue of a patient, wherein each augmented image associates at least one tissue parameter with a region or pixel of the image of the tissue, said method comprising the following steps: obtaining one or more multispectral images of said tissue, and applying a machine learning based regressor or classifier, or an out of distribution (OoD) detection algorithm for determining information about the closeness of the multispectral image or parts of said multispectral image to a given training data set, or a change detection algorithm to at least a part of said one or more multispectral images, or an image derived from said multispectral image, or to a time sequence of multispectral images, parts of multiple images or images derived therefrom, to thereby derive one or more tissue parameters associated with image regions or pixels of the corresponding multispectral image.

### SUMMARY OF THE INVENTION

The invention provides for a medical system, a computer program and a method in the independent claims. Embodiments are given in the dependent claims.

As was mentioned above, artificial intelligence may be used for image reconstruction and image processing and enhancement. A particular difficulty for applying these techniques for medical imaging is that if the data being input into a trainable machine learning module is outside of the training data distribution then the reconstructed medical image which is produced using the trainable machine learning module may be incorrect. The resulting reconstructed medical image may look like a correct medical image, but it is not correct.

Various techniques have been developed to detect if the data input into a trainable machine learning module have been developed. A problem with these techniques is that they are typically not broadly applicable and may only work in a narrow set of circumstances. That is to say that they themselves may give unreliable results.

Embodiments may provide a better means of detecting if the measured medical image data input into a trainable machine learning module will yield correct results or not. Embodiments may achieve this by using a hierarchy or sequence of different software modules each configured to detect data which is outside of the training data distribution by different amounts. In one example an out-of-distribution estimation module and a in-distribution accuracy estimation module are used sequentially. In another example an anomaly detection module is additional used.

In one aspect the invention provides for a medical system that comprises a memory that stores machine-executable instructions. The memory also stores a trainable machine learning module trained using training data descriptive of a training distribution and is configured to output a reconstructed medical image in response to receiving a measured medical image data as input. The training data distribution is a distribution of data which the trainable machine learning module is ideally configured for reconstructing images of. The training data is a subsample or portion that is intended to represent the full training data distribution. The measured medical image data may take different forms in different examples. In one example the measured medical image data may be in image space. In other examples the measured medical image data may also be measurements made by a medical imaging system such as the raw data for a magnetic resonance imaging system or absorption lines for a computed tomography system. In yet other examples the measured medical image data may include both these measurements for a medical imaging system as well as images in image space.

The memory further stores an out-of-distribution estimation module that has been configured or trained for outputting an out-of-distribution score in response to receiving the measured medical image data. An out-of-distribution estimation module, as used herein, encompasses a software module that is used to detect if data is within the training data distribution or not. The out-of-distribution score is descriptive of a probability that the measured medical image is within the training data distribution. The memory further stores an in-distribution accuracy estimation module configured for outputting an in-distribution accuracy score descriptive of a probability that the reconstructed medical image is accurate. For example, when the trainable machine learning module reconstructs the reconstructed medical image there is a probability that the reconstructed medical image is incorrect. The in-distribution accuracy score may for example be a probability that estimates whether the reconstructed medical image has been reconstructed correctly.

The medical system further comprises a computational system. The computational system may take different forms in different examples. In one example the computational system may be a workstation or computing system, such would be used by a radiologist or other medical professional to examine radiological or other medical images. In other examples, the computational system may be a remote or cloud-based system that is used for reconstructing the reconstructed medical images remotely. In yet other examples, the computational system may for example be a computer or other control or system which is used to control the operation and function of a medical imaging system. For example, the computational system may be a console integrated into a magnetic resonance imaging system, a computed tomography system, an ultrasound system or other medical imaging system.

Execution of the machine-executable instructions causes the computational system to receive the measured medical image data. Receiving the measured medical image data may for example be retrieving it from a storage device such as a hard drive or other unit or retrieving it via a network connection. In yet other examples, receiving the measured medical image data may include controlling a medical imaging system to acquire it.

Execution of the machine-executable instructions further causes the computational system to determine the out-of-distribution score and the in-distribution accuracy score consecutively in an order determined by a sequence. The out-of-distribution score is determined by inputting the measured medical image data into the out-of-distribution estimation module. The in-distribution accuracy score is determined by inputting the measured medical image data into the in-distribution estimation accuracy module. The sequence is used to determine in which order the out-of-distribution score and the in-distribution accuracy score are determined. For example, if one of the two in the case that the trainable machine learning module would likely give an error, then the operation can be truncated or aborted before performing the other of the out-of-distribution score and the in-distribution accuracy score.

Execution of the machine-executable instructions further causes the computational system to detect a rejection of the measured medical image data using the out-of-distribution score and/or the in-distribution accuracy score during execution of the sequence. Execution of the machine-executable instructions further causes the computational system to provide a warning signal if the rejection of the measured medical image data is detected. This warning signal may take different forms in different examples. In one example it may just be a signal that is presented to an operator. In the case where the computational system is controlling a medical imaging system the warning signal may for example be used to cause the medical imaging system to reacquire data and/or to cancel the acquisition operation. In yet other examples the warning signal may be logged or appended to Meta data for an image.

The trainable machine learning module may take different forms in different examples. In one example it may be an image processing neural network. In this case the image processing neural network may receive the measured medical image data and then output the reconstructed medical image in response. Various image processing tasks could for example be performed. A specific example of an image processing neural network that is common for medical imaging systems would be a so-called U-Net neural network. In other examples the trainable machine learning module could be an SVM or support vector machine. In yet other examples, the trainable machine learning module could be a hybrid model where one or more neural networks are used to perform image reconstruction using the measured medical image data as the input.

In one example the image data is in image space. The trainable machine learning module then performs an image processing or filtering task. In yet other examples, the measured medical image data is the measured or raw data from a measurement by a medical imaging system. A specific example for a magnetic resonance imaging system would be that the measured medical image data is k-space data and/or images reconstructed from this k-space data.

In another embodiment the measured medical image data is a portion of the medical image data that is available. For example, the measured medical image data may be image data selected from a region of interest of a different medical image or dataset.

In another embodiment execution of the machine-executable instructions further causes the computational system to provide the reconstructed medical image by at least partially inputting the measured medical image system into the trainable machine learning module after completion of the sequence. This example may be beneficial because it provides for a means of evaluating the quality of the measured medical image data before performing the reconstruction of the reconstructed medical image. The trainable machine learning module may be implemented as a complete learning module such as an SVM or neural network or it may also be included as part of a hybrid system. A concrete example of this would be where the trainable machine learning module is used in a compressed sensing image reconstruction. Neural networks could be used for example for the reconstruction of the image in an iterative fashion and/or for data consistency routines.

In another embodiment the memory further stores an anomaly detection estimation module that is configured for outputting an anomaly estimate score in response to receiving the measured medical image data. An anomaly detection estimation module, as used herein, is a software module that is configured for detecting if the data input into it is anomalous in comparison to a set of training data. The anomaly estimation score is descriptive of a probability that the measured medical image is anomalous in comparison to the training data distribution. Execution of the machine-executable instructions further causes the computational system to determine the anomaly estimation score consecutively with the out-of-distribution score and the in-distribution accuracy score in the order determined by the sequence.

The anomaly estimation score is determined by inputting the measured medical image data into the anomaly detection estimation module. Execution of the machine-executable instructions further causes the computational system to detect a rejection of the measured medical image data using the anomaly estimation score during execution of the sequence. This embodiment may be beneficial because it may provide for an additional means of detecting if the trainable machine learning module will output a reconstructed medical image that is correct in response to inputting the measured medical image data.

In another embodiment the sequence is predetermined. This embodiment may be beneficial because the computational requirements of the different software modules may be known in advance. They can for example be selected so that they reduce the computational burden on the computational system and determine if the measured medical image data will yield a correct image or not.

In another embodiment, preferably the input of the measured medical image data into the anomaly detection estimation module is performed before the input into the out-of-distribution estimation module. This embodiment is beneficial because the anomaly detection estimation module probably requires less computational resources than the in-distribution accuracy estimation module.

In another embodiment the input of the measured medical image data into the out-of-distribution estimation module is performed before the input into the in-distribution accuracy estimation module. This embodiment may also be beneficial because the in-distribution accuracy estimation module may be computationally easier than using the in-distribution accuracy estimation module.

In another embodiment the anomaly detection estimation module comprises an auto encoder that is trained with samples from the training data distribution. The anomaly estimation score is provided as a measure of a difference between the input and output of the auto encoder. Auto encoders are typically trained to receive an image or other data as input and then to re-output the same data typically with noise removed. If the auto encoder was not properly trained, for example, it wasn't trained to detect certain anomalies, then the auto encoder would output a bad data. For example, the input and the output of the auto encoder can be compared and their similarity can be measured. If they differ by more than a predetermined amount, then this can be used for detecting anomalies.

In another embodiment the anomaly detection estimation module is a density-based algorithm configured using predetermined features.

In another embodiment the memory further contains an image classifier neural network trained to determine the sequence in response to receiving the measured medical image data as input. Execution of the machine-executable instructions further causes the computational system to determine the sequence by inputting the measured medical image into the image classifier neural network. For example, the image classifier neural network could be trained to recognize certain types of artifacts or anomalous image artifacts. The image classifier neural network can then be used to essentially short circuit or select the most computationally efficient way of determining if the measured medical image data will yield a good result.

In another embodiment the medical system further comprises a medical imaging system. Execution of the machine-executable instructions further causes the processor to control the medical imaging system to acquire the measured medical image data.

In another embodiment the medical imaging system is a magnetic resonance imaging system.

In another embodiment the medical imaging system is a computed tomography system.

In another embodiment the medical imaging system is a positron emission tomography system.

In another embodiment the medical imaging system is a single photon emission tomography system.

In another embodiment the medical imaging system is an ultrasound system.

In another embodiment the medical imaging system is an X-ray system.

In another embodiment the medical imaging system is a digital fluoroscope system.

In another embodiment the measured medical image data is an under-sampled magnetic resonance image. The reconstructed medical image is a simulation of a fully sampled magnetic resonance image. Recently neural networks for example, have been used for reconstructing or creating magnetic resonance images from under-sampled magnetic resonance image data. A risk in doing this is that the neural network may reconstruct an image which does not resemble the actual image. This embodiment may be beneficial because the measured medical image data can be rejected before a reconstruction is performed.

In another embodiment the warning signal causes a re-acquisition of the measured medical image data.

In another embodiment the warning signal causes a display of the warning signal on a display.

In another embodiment the warning signal causes the appending of Meta data descriptive of the warning signal and/or the measured medical image data to the reconstructed medical image. For example, the reconstructed medical image may be contained in an encapsulated data format such as DICOM. The Meta data descriptive of the warning signal could for example be inserted into the DICOM file.

In another embodiment the warning signal causes the current reconstruction algorithm to be aborted and to select an alternative reconstruction algorithm to reconstruct the reconstructed medical image. A concrete example of this would be a SENSE reconstruction. Neural networks can be used in a SENSE reconstruction. If it is detected that the warning signal is there then it may be advantageous to use a conventional SENSE reconstruction algorithm.

In another embodiment the measured medical image data is formatted in image space. The trainable machine learning module is formatted as an image processing module. A specific example would be a neural network that is trained to perform image processing. In general, the trainable machine learning module could for example be configured to perform denoising, post-processing imaging enhancement and/or image artifact removal from the measured medical image data.

In another embodiment the measured medical image data comprises medical imaging system measurements. These for example are the actual measurements taken by the medical imaging system during the scanning of the subject. This for example would be k-space data in the case of magnetic resonance imaging.

In another embodiment the measured medical image data comprises medical imaging system measurements and image space data. For example, the trainable machine learning module may be formatted to take the actual measurements from the medical imaging system and data which is in image space. Another example of this is the reconstruction of a SENSE image. In this technique the data is under-sampled and the image is reproduced repeatedly. After reconstruction of the image there is a data consistency step, where the image is compared to the medical imaging system measurements. A neural network could be specially trained for the image reconstruction of each iteration of the image. In another example a second neural network could be sued for the data consistency step. In this further example, the image from the previous iteration as well as the medical imaging system measurements would be input into the second neural network.

A concrete example would be a trainable machine learning module that receives the medical image to be enhanced either by denoising, computer super resolution, motion correction or a combination. Another example would be a trainable machine learning module that receives raw data from the medical system and computes a medical image or a medical image reconstruction.

Another example would be a trainable machine learning module that receives a medical image to be enhanced and the original raw data or medical imaging system measurements are used to generate such an image. The result can be a denoised image, a super resolution version, a motion correction image or a combination thereof. The raw data supports the enhancement procedure by compensating for deviations from the reference data that were originally acquired. This is in some ways analogous to a SENSE reconstruction.

For the examples above the models may compute or consist of a series of computing layers that transform the raw data into a medical image. The computing layer may be learnt, for example convolutions with learned filter bags or traditional computation such as a fast Fourier transform. The model can be executed by chaining the operations into a directed acyclic graph that models the execution or by executing them as an imperative program.

In another embodiment the out-of-distribution estimation module is implemented by computing the output of several trained neural networks and computing the variance of their prediction. Rejection of the measured medical image data is performed if the variance is higher than a predetermined threshold.

In another embodiment the out-of-distribution estimation module is implemented as a density-based rejection algorithm based on predetermined features to perform out-of-distribution estimation.

In another embodiment the out-of-distribution estimation module is implemented as a statistical characterization of hidden layer neural activations. For example, the trainable machine learning module can be implemented as a neural network. The contents of a single hidden layer or multiple hidden layers or portions of these hidden layers can be monitored for the training data. A statistical characterization of the response of these chosen portions of the hidden layer for the training distribution can then be developed. When the measured medical imaging data is input into this neural network the values of the hidden layer activations can be compared to this statistical characterization. If they are out of a particular range then the rejection of the measured medical image data can be performed.

In another embodiment the trainable machine learning module is configured to output multiple versions of the reconstructed medical image using different random initializations. For example, the machine learning module may be configured as a neural network. The same training data can be used but the initialization of the neural network when it is trained can be modified. This means that the output of the neural network would be expected to be consistent when the data is within the training distribution. However, if the measured medical imaging data is outside of the training distribution then it would be expected that the results from the different random initializations would indicate that it is out of distribution. The in-distribution accuracy score is determined using a statistical comparison between the multiple versions.

In another aspect the invention provides for a computer program comprising machine-executable instructions for execution by a computational system controlling a medical system. The computer program further comprises a trainable machine learning module trained using training data descriptive of a training data distribution to output a reconstructed medical image in response to receiving a measured medical imaging data as input. The computer program further comprises an out-of-distribution estimation module configured for outputting an out-of-distribution score in response to receiving the measured medical image data. The out-of-distribution score is descriptive of a probability that the measured medical image is within the training data distribution. The computer program further comprises an in-distribution accuracy estimation module configured for outputting an in-distribution accuracy score descriptive of a probability that the reconstructed medical image is accurate.

Execution of the machine-executable instructions causes the computational system to receive the measured medical image data. Execution of the machine-executable instructions further causes the computational system to determine the out-of-distribution score and the in-distribution accuracy score consecutively in an order determined by a sequence. The out-of-distribution score is determined by inputting the measured medical image data into the out-of-distribution estimation module. The in-distribution accuracy score is determined by inputting the measured medical image data into the in-distribution accuracy estimation module.

Execution of the machine-executable instructions further causes the computational system to detect a rejection of the measured medical image data using the out-of-distribution score and/or the in-distribution accuracy score during execution of the sequence. Execution of the machine-executable instructions further causes the computational system to provide a warning signal if the rejection of the measured medical image data is detected.

In another aspect the invention provides for a method of medical imaging using a trainable machine learning module, an out-of-distribution estimation module, and an in-distribution accuracy estimation module. The trainable machine learning module is trained using training data descriptive of a training data distribution and is configured to output a reconstructed medical image in response to receiving a measured medical image data as input. The out-of-distribution estimation module is configured for outputting an out-of-distribution score in response to receiving the measured medical image data. The out-of-distribution score is descriptive of a probability that the measured medical image is within the training data distribution. The in-distribution accuracy estimation module is configured for outputting an in-distribution accuracy score descriptive of a probability that the reconstructed medical image is accurate.

The method comprises receiving the measured medical image data. The method further comprises determining an out-of-distribution score and an in-distribution accuracy score consecutively in an order determined by a sequence. The out-of-distribution score is determined by inputting the measured medical image data into an out-of-distribution estimation module. The in-distribution accuracy score is determined by inputting the measured medical image data into the in-distribution accuracy estimation module. The method further comprises detecting a rejection of the measured medical image data using the out-of-distribution score and/or the in-distribution accuracy score during execution of the sequence. The method further comprises providing a warning signal if the rejection of the measured medical image data is detected.

It is understood that one or more of the aforementioned embodiments of the invention may be combined as long as the combined embodiments are not mutually exclusive.

As will be appreciated by one skilled in the art, aspects of the present invention may be embodied as an apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon.

Any combination of one or more computer readable medium(s) may be utilized. The computer readable medium may be a computer readable signal medium or a computer readable storage medium. A ‘computer-readable storage medium’ as used herein encompasses any tangible storage medium which may store instructions which are executable by a processor or computational system of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the computational system of the computing device. Examples of computer-readable storage media include, but are not limited to: a floppy disk, a magnetic hard disk drive, a solid state hard disk, flash memory, a USB thumb drive, Random Access Memory (RAM), Read Only Memory (ROM), an optical disk, a magneto-optical disk, and the register file of the computational system. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example, data may be retrieved over a modem, over the interne, or over a local area network. Computer executable code embodied on a computer readable medium may be transmitted using any appropriate medium, including but not limited to wireless, wire line, optical fiber cable, RF, etc., or any suitable combination of the foregoing.

A computer readable signal medium may include a propagated data signal with computer executable code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

‘Computer memory’ or ‘memory’ is an example of a computer-readable storage medium. Computer memory is any memory which is directly accessible to a computational system. ‘Computer storage’ or ‘storage’ is a further example of a computer-readable storage medium. Computer storage is any non-volatile computer-readable storage medium. In some embodiments computer storage may also be computer memory or vice versa.

A ‘computational system’ as used herein encompasses an electronic component which is able to execute a program or machine executable instruction or computer executable code. References to the computational system comprising the example of “a computational system” should be interpreted as possibly containing more than one computational system or processing core. The computational system may for instance be a multi-core processor. A computational system may also refer to a collection of computational systems within a single computer system or distributed amongst multiple computer systems. The term computational system should also be interpreted to possibly refer to a collection or network of computing devices each comprising a processor or computational systems. The machine executable code or instructions may be executed by multiple computational systems or processors that may be within the same computing device or which may even be distributed across multiple computing devices.

Machine executable instructions or computer executable code may comprise instructions or a program which causes a processor or other computational system to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances, the computer executable code may be in the form of a high-level language or in a pre-compiled form and be used in conjunction with an interpreter which generates the machine executable instructions on the fly. In other instances, the machine executable instructions or computer executable code may be in the form of programming for programmable logic gate arrays.

The computer executable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It is understood that each block or a portion of the blocks of the flowchart, illustrations, and/or block diagrams, can be implemented by computer program instructions in form of computer executable code when applicable. It is further under stood that, when not mutually exclusive, combinations of blocks in different flowcharts, illustrations, and/or block diagrams may be combined. These computer program instructions may be provided to a computational system of a general purpose computer, special purpose computer, or other programmable data processing apparatus to produce a machine, such that the instructions, which execute via the computational system of the computer or other programmable data processing apparatus, create means for implementing the functions/acts specified in the flowchart and/or block diagram block or blocks.

These machine executable instructions or computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The machine executable instructions or computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A ‘user interface’ as used herein is an interface which allows a user or operator to interact with a computer or computer system. A ‘user interface’ may also be referred to as a ‘human interface device.’ A user interface may provide information or data to the operator and/or receive information or data from the operator. A user interface may enable input from an operator to be received by the computer and may provide output to the user from the computer. In other words, the user interface may allow an operator to control or manipulate a computer and the interface may allow the computer to indicate the effects of the operator's control or manipulation. The display of data or information on a display or a graphical user interface is an example of providing information to an operator. The receiving of data through a keyboard, mouse, trackball, touchpad, pointing stick, graphics tablet, joystick, gamepad, webcam, headset, pedals, wired glove, remote control, and accelerometer are all examples of user interface components which enable the receiving of information or data from an operator.
A ‘hardware interface’ as used herein encompasses an interface which enables the computational system of a computer system to interact with and/or control an external computing device and/or apparatus. A hardware interface may allow a computational system to send control signals or instructions to an external computing device and/or apparatus. A hardware interface may also enable a computational system to exchange data with an external computing device and/or apparatus. Examples of a hardware interface include, but are not limited to: a universal serial bus, IEEE 1394 port, parallel port, IEEE 1284 port, serial port, RS-232 port, IEEE-488 port, Bluetooth connection, Wireless local area network connection, TCP/IP connection, Ethernet connection, control voltage interface, MIDI interface, analog input interface, and digital input interface.

A ‘display’ or ‘display device’ as used herein encompasses an output device or a user interface adapted for displaying images or data. A display may output visual, audio, and or tactile data. Examples of a display include, but are not limited to: a computer monitor, a television screen, a touch screen, tactile electronic display, Braille screen, Cathode ray tube (CRT), Storage tube, Bi-stable display, Electronic paper, Vector display, Flat panel display, Vacuum fluorescent display (VF), Light-emitting diode (LED) displays, Electroluminescent display (ELD), Plasma display panels (PDP), Liquid crystal display (LCD), Organic light-emitting diode displays (OLED), a projector, and Head-mounted display.

Medical imaging system measurements is defined herein as being recorded measurements made by a medical imaging system descriptive of a subject. The medical imaging system measurements may be reconstructed into a medical image. A medical image id defined herein as being the reconstructed two- or three-dimensional visualization of anatomic data contained within the medical imaging data. This visualization can be performed using a computer.

K-space data is defined herein as being the recorded measurements of radio frequency signals emitted by atomic spins using the antenna of a Magnetic resonance apparatus during a magnetic resonance imaging scan. Magnetic resonance data is an example of medical imaging system measurements.

A Magnetic Resonance Imaging (MRI) image or MR image is defined herein as being the reconstructed two- or three-dimensional visualization of anatomic data contained within the magnetic resonance imaging data. This visualization can be performed using a computer.

### BRIEF DESCRIPTION OF THE DRAWINGS

In the following preferred embodiments of the invention will be described, by way of example only, and with reference to the drawings in which:

FIG. 1 illustrates an example of a medical system;

FIG. 2 shows a flow chart which illustrates a method of using the medical system of FIG. 1 or FIG. 3;

FIG. 3 illustrates a further example of a medical system;

FIG. 4 illustrates a further example of a medical system;

FIG. 5 shows a flow chart which illustrates a method of using the medical system of FIG. 4;

FIG. 6 shows an illustration which depicts a training data distribution;

FIG. 7 illustrates the relative effectiveness of different means of detection out of distribution for different categories of input data;

FIG. 8 shows a flow chart which illustrates a method;

FIG. 9 shows a flow chart which illustrates a further method;

FIG. 10 illustrates two examples of mean activations of feature maps; and

FIG. 11 illustrates out of distribution detection using in-distribution neuron activation.

### DETAILED DESCRIPTION OF EMBODIMENTS

Like numbered elements in these figures are either equivalent elements or perform the same function. Elements which have been discussed previously will not necessarily be discussed in later figures if the function is equivalent.

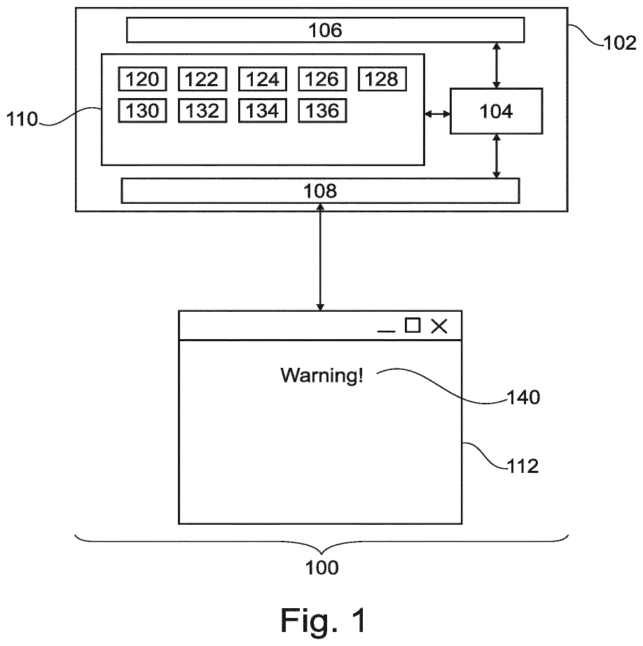

FIG. 1 illustrates an example of a medical system 100. The medical system 100 is shown as comprising a computer 102. The computer 102 comprises a computational system 104. In this particular example the computational system 104 may be one or more processing cores. However, the computer 102 and the computational system 104 could represent multiple computer systems and multiple computation systems that are distributed locally or across a network. The computational system 104 is shown as being connected to an optional hardware interface 106 and an optional user interface 108. The hardware interface 106 may enable the computational system 104 to communicate with other computer systems as well as control other components of the medical system 100. The user interface 108 may enable an operator to interact with the medical system 100.

The computational system 104 is further shown as being connected to a memory 110. The optional user interface 108 comprises an optional graphical user interface 112 that may for example be provided by a display or touchscreen.

The memory 110 is intended to represent any type of memory which may be connected or accessible by the computational system 104. This may include various volatile and non-volatile memory types. The memory 110 is shown as storing machine-executable instructions 120. The machine-executable instructions 120 contain instructions which enable the computational system 104 to perform various computational tasks, control the medical system 100 as well as provide various numerical and image processing routines. The memory 110 is further shown as containing or storing a trainable machine learning module 122. The trainable machine learning module is configured for receiving a measured medical image and in response outputting a reconstructed medical image. The trainable machine learning module 122 may either be a pure machine learning algorithm or it may be a hybrid algorithm which combines some algorithmic steps used for the reconstruction of the image.

The memory 110 is further shown as containing an out-of-distribution estimation module 124 and an in-distribution accuracy estimation module 126. The memory 110 is further shown as containing measured medical image data 128. The measured medical image data 128 is then input into the out-of-distribution estimation module 124 to provide an out-of-distribution score 130. The measured medical image data 128 is also input into the in-distribution accuracy estimation module 126 to provide an in-distribution accuracy score 132. The trainable machine learning module 122 is trained using training data that is descriptive or representative of a training data distribution. The out-of-distribution score 130 provides a probability that the measured medical imaging data is within the training data distribution. The in-distribution accuracy score 132 provides a number which is descriptive of a probability that the reconstructed medical image is accurate. If either of the out-of-distribution score 130 or the in-distribution accuracy score 132 have probabilities above a predetermined threshold then a warning signal 134 may be provided. The memory 110 is further shown as containing an optional reconstructed medical image 136 that is reconstructed at least partially using the trainable machine learning module 122.

If the warning signal is provided 134, then on the graphical user interface 112 an optional warning 140 may be provided. The warning signal 134 may be brought to the attention of operators/users in different ways. In some examples, if the medical system includes the medical imaging system the warning signal 134 may be used for the re-acquisition or the change of a reconstruction algorithm. In other examples the warning signal 134 may simply be appended to the reconstructed medical image 136.

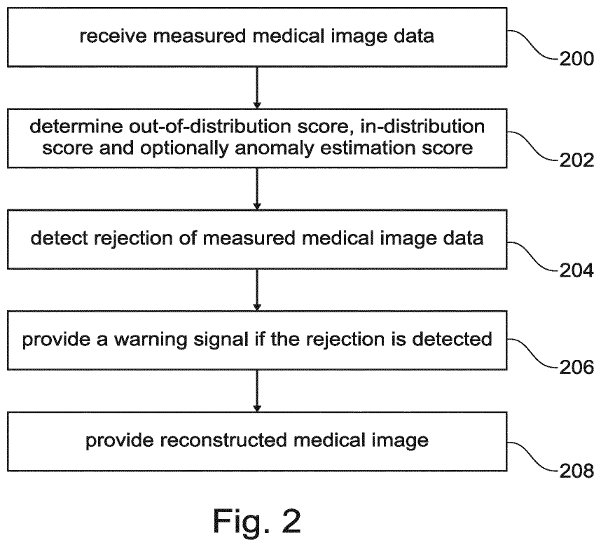

FIG. 2 shows a flowchart which illustrates a method of operating the medical system 100 of FIG. 1. First, in step 200, the measured medical image data 128 is received. Next, in step 202, the out-of-distribution score 130 and/or the in-distribution accuracy score 132 are determined. These are determined by inputting the measured medical image data 128 into the out-of-distribution estimation module 124 and the in-distribution accuracy estimation module 126. Next, in step 204, a rejection of the measured medical image data 128 is detected using the out-of-distribution score 130 and/or the in-distribution accuracy score 132 using a sequence. For example, one may be determined before the other and either one may be used to detect a rejection of the measured medical image data 128. Next, the method proceeds to step 206. A warning signal 134 is provided if the rejection of the measured medical image data 128 is detected.

FIG. 2 also shows an optional step 208 that is performed after step 206. In step 208, the reconstructed medical image 136 is provided at least partially by inputting the measured medical image data 128 into the trainable machine learning module 122.

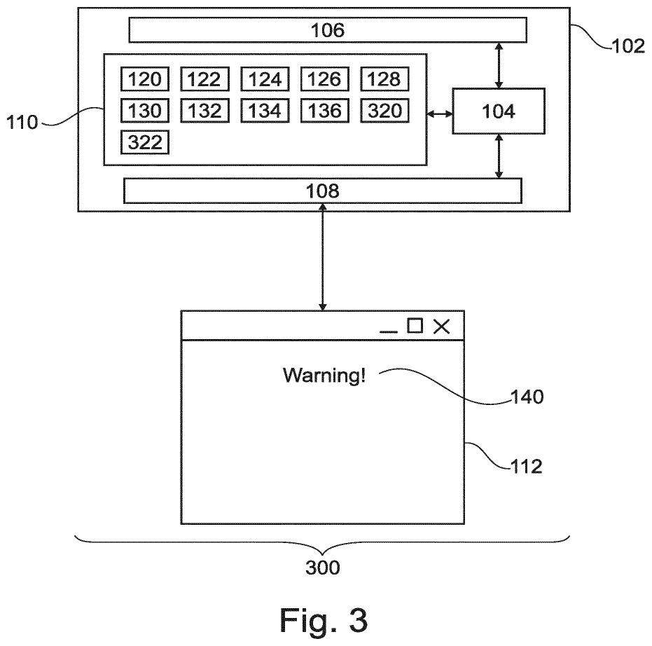

FIG. 3 shows a further example of a medical system 300. The medical system illustrated in FIG. 3 is similar to the medical system 100 depicted in FIG. 1. The memory 110 is shown as containing several additional items. The memory 110 is further shown as containing an anomaly detection estimation module 320. The anomaly detection estimation module 320 is configured for outputting an anomaly estimation score in response to receiving the measured medical image data. The anomaly estimation score is descriptive of a probability if the measured medical image is anomalous in comparison to the training data distribution. The memory 110 is also shown as containing the anomaly estimation score 322, which was obtained in response to inputting the measured medical image data 128 into the anomaly detection estimation module 320. The method illustrated in FIG. 2 can be modified to operate the medical system 300 of FIG. 3. In step 202 the anomaly estimation score 322 can also be determined by inputting the measured medical image data 128 into the anomaly detection estimation module 320. Then in steps 204, the rejection of the measured medical image data 128 would also be determined using the anomaly estimation score 322.

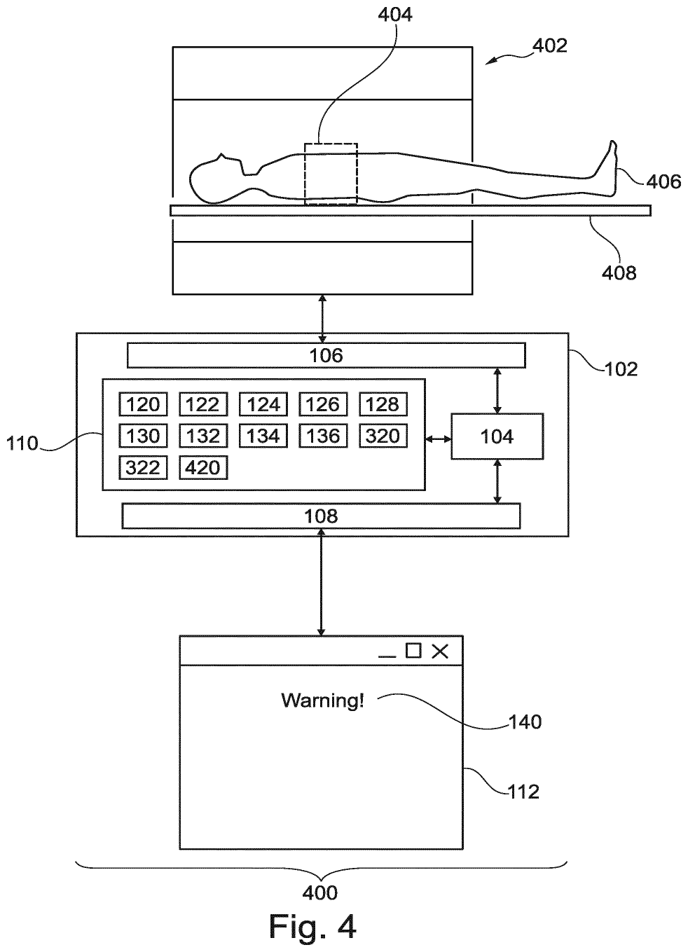

FIG. 4 illustrates a further example of a medical system 400. The medical system 400 is similar to that depicted in FIG. 3 except that it additionally comprises a medical imaging system 402. The medical imaging system 402 is intended to be representative. The medical imaging system could for example, but is not limited to, be a magnetic resonance imaging system, a computed tomography system, a positron emission tomography system, a single photon emission tomography system, an ultrasound system, a digital X-ray system, and a digital fluoroscope.

In this particular example a subject 406 is shown as reposing on a subject support 408 which supports a portion of the subject 406 within an imaging zone 408. The machine-executable instructions 120 cause the computational system 104 to control the medical imaging system 402 via the hardware interface 106. The machine-executable instructions 120 control the medical imaging system 402 to acquire medical imaging system measurements 420. These are the measurements which are then reconstructed into a medical image later. The measured medical image data 128 could either be the medical imaging system measurements 420, or an image reconstructed from the medical imaging system measurements 420. In some instances, the measured medical image data 128 comprises both the reconstructed image and the raw data or the medical imaging system measurements 420.

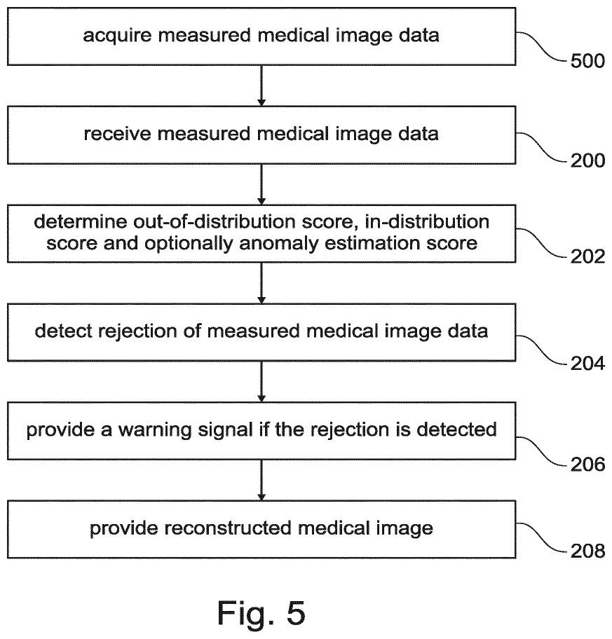

FIG. 5 shows a flowchart which illustrates a method of operating the medical system 400 of FIG. 4. The method starts with step 500 and the medical imaging system 402 acquires the medical imaging system measurements 420. This either provides the measured medical image data 128 directly or there is an image reconstruction from the medical imaging system measurements 420 which is used to provide the measured medical image data 128. The method then proceeds to step 200 as is depicted in FIG. 2.

Deep Learning based solutions (or other trainable machine learning module) can be used for reconstructing heavily undersampled medical images, for example using magnetic resonance (MR) k-space data. Since less data has to be acquired in the scanner, examination time can be greatly reduced. Another application is the denoising of extremely low-dose CT scans, resulting in lower radiation for the patients.

However, compared to traditional techniques, Deep Learning based solutions are difficult to control. It is often observed that, when the data to be processed is too dissimilar from the data used during training (out-of-distribution), Deep Learning solutions for medical imaging applications may produce realistic images that are different from the true anatomy. Because the artefacts look like true anatomy, a radiologist cannot identify them as such. This could lead to a misinterpretation impacting diagnosis, reduced confidence in product value/quality, and/or additional burden for the radiologist.

Examples may provide a means for estimating whether the input image to be processed by a deep neural network is well explained by the training data distribution, i.e., sufficiently similar input were present in the dataset used for training, hence resulting in reliable results. In this invention, we observe that a single algorithm does not provide a satisfactory out-of-training-distribution (OOD) estimation. Therefore, we propose a staged computation, where multiple algorithms are used to sequentially estimate the OOD level for an input to the deep learning algorithm; overcoming the limitations of each individual solution.

Examples can be applied in several settings. It can be used to detect pathologies previously unseen by an AI algorithm, bad images due to faulty hardware components or images affected by motion artifacts. This invention will allow the application of Deep Learning solutions in a practical setting.

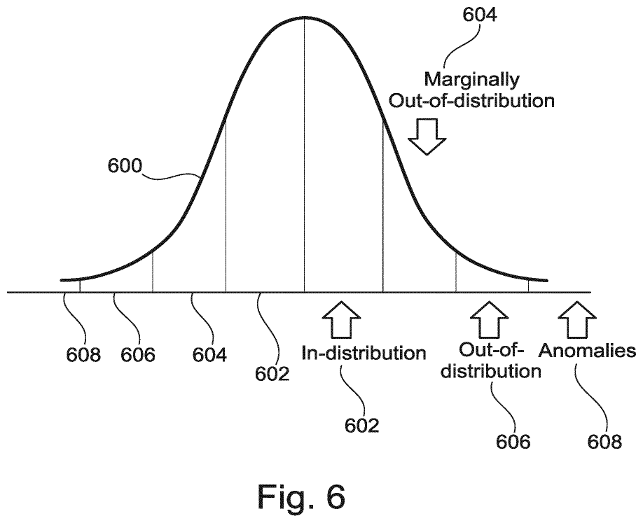

The data which can be input into the trainable machine learning module 122 (such as a neural network) is ideally from the training data distribution. The performance of the trainable machine learning module 122 will depend upon how well the measured medical image data 128 is within the training data distribution. FIG. 6 shows a curve, which is intended to represent the training data distribution 600. The area under the curve 600 has been broken into a number of different regions. If the data matches the training data distribution 600 well it will be in distribution 602. If it is only marginally out-of-distribution 600 it will be marginally out-of-distribution in region 604. Data that is outside of the training data distribution 600 is labeled out-of-distribution data 606. When the data essentially does not match the training data distribution at all it is determined as being anomalous and is in region 608. There exist different methods for detecting if the data is within one of these regions 602, 604, 606, 608. A combination of different types of modules are used to preferentially determine each of these regions. For example, the anomaly detection estimation module 320 is particularly efficient at detecting anomalies in region 608. The out-of-distribution estimation module 124 is particularly good at detecting data in the out-of-distribution region 606. The in-distribution accuracy estimation module 126 is good at differentiating between data that is within the in-distribution region 602 and the marginally out-of-distribution region 604.

Examples may provide a means for estimating whether the input image to be processed by a deep neural network is well explained by the training data distribution, i.e., sufficiently similar input were present in the dataset used for training, hence resulting in reliable results. Deep learning algorithms assume IID data (independent and identically distributed), which is not true in practice. As described above, FIG. 6 depicts a more truthful representation, showing that the data contains:
1. in-distribution data 602, which are well represented in the training set
2. marginally out-of-distribution 604, which were under-represented in the training data and can result in lower performance. Note that is often not possible to include this data in the training set due to theoretical limitations, i.e., data affected by heavy noise
3. out-of-distribution data 606, which were not included into the training set and where poor performance is to be expected.
4. Severely out-of-distribution (anomalies) 608, i.e. data that contains severe deviations from the original distribution of data, for example by defining completely different input to output relationships

Several solutions have been presented for OOD estimation, but they perform well on only one of the four sub-sets presented above. Anomaly detection is often performed through some sort of dimensionality reduction, for example by adopting some sort of autoencoder architecture. These approaches are often fast to compute but are not precise enough to detect minor changes in the data distribution.

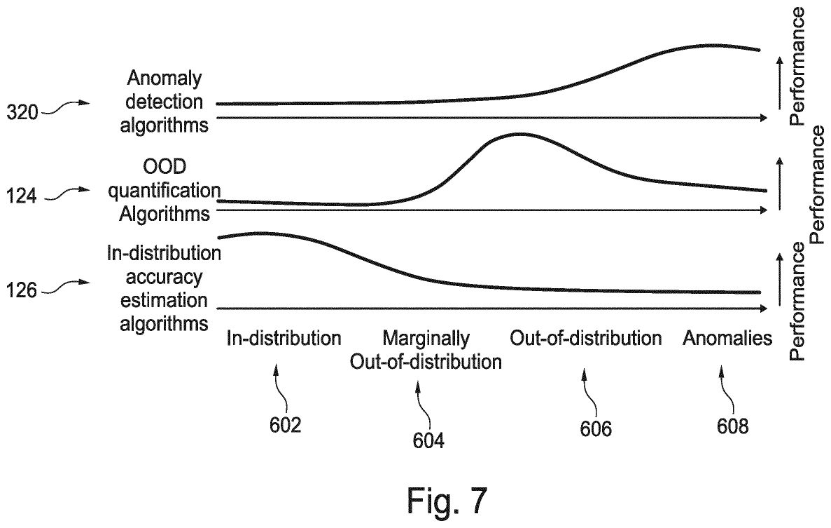

Overall, it is noted that rough estimations of the OOD are efficient to compute, requiring small models that can be executed rather fast. More precise, i.e., with higher specificity OOD estimation requires more computation, moreover, it becomes unreliable if the that is severely out of distribution, i.e., resulting in lower sensitivity. FIG. 7 highlights this fact.

FIG. 7 illustrates the performance of the anomaly detection estimation module 320, the out-of-distribution estimation module 124 and the in-distribution accuracy estimation module 126 in the in-distribution region, the marginally out-of-distribution region 604, the out-of-distribution region 606 and in the anomalous region 608. FIG. 7 illustrates why it may be advantageous to use all three modules 320, 124, and 126. FIG. 7 illustrates the performance of different categories of algorithms vs how far the input sample is outside the distribution. Note that anomaly detection algorithms are often more computationally efficient than OOD quantification algorithms, which in turns are more efficient than precise accuracy estimation algorithms.

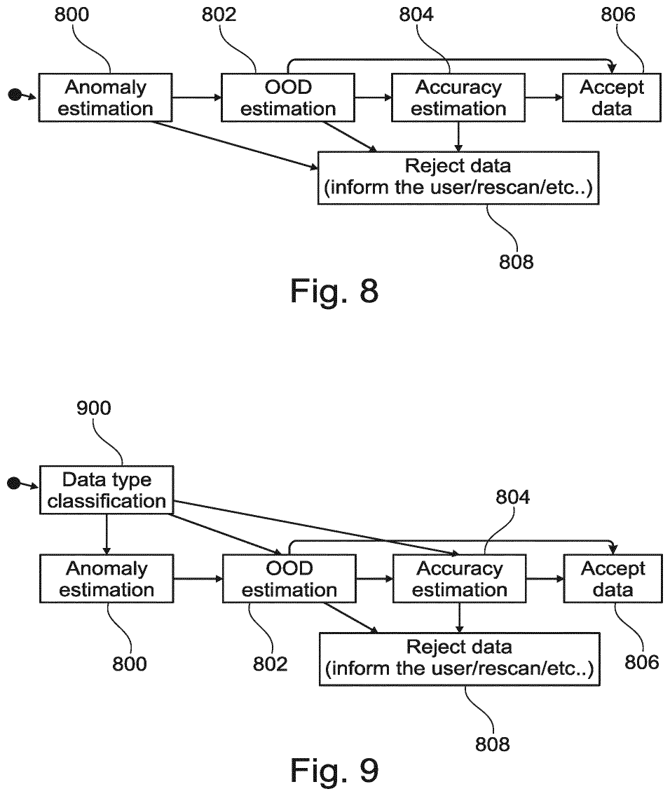

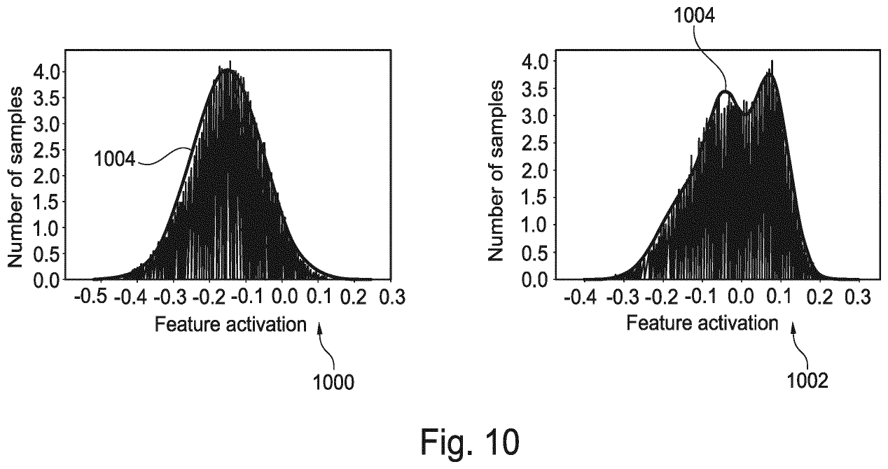

Examples may provide for a staged approach to compute how reliable is the output of a deep learning model for medical images. Some examples start from an efficient anomaly detection algorithm (anomaly detection estimation module) and test whether the data (measured medical image data) is subject of a severe distribution shift. If no anomaly is detected, an OOD quantification is performed (using the out-of-distribution estimation module). If the resulting OOD estimation is within acceptable range, an in-distribution accuracy estimation can be performed. FIG. 8 shows an overview of two example out-of-distribution computation pipeline. In a second example shown in FIG. 9, a classifier 900 is trained to detect at which stage of the OOD pipeline is more efficient to start the OOD computation. Algorithms characterized by high sensitivity in the early phase of the pipeline, i.e., may not be able to not reject acceptable data in most working conditions. The following steps may have increased specificity, such that no OOD data is considered acceptable by our computations. Note that the same algorithm can be used in the different steps, if different parameterizations are used resulting in different sensitivity and specificity.

FIG. 8 shows a flowchart which illustrates an example of a method. In FIG. 8 there is a sequential or sequence of applying the anomaly detection estimation module 320, the out-of-distribution estimation module 124 and the in-distribution accuracy estimation module 126. First, anomaly estimation 800 is performed using the anomaly detection estimation module 320. If an anomaly is detected then the method proceeds to step 808 and the data is rejected. In this case the measured medical image data 128 is rejected. If the data passes the anomaly estimation 800 it then proceeds to the out-of-distribution estimation 802 using the out-of-distribution estimation module 124. If this is failed the data is then rejected in step 808. If not, the method proceeds to the accuracy estimation in step 804. In step 804 the in-distribution accuracy estimation module 126 is used to evaluate the accuracy and predict if the data should be accepted in step 806. The data can be rejected at any of steps 800, 802, and 804. In some instances, the out-of-distribution estimation 802 can be used to directly accept the data 806. In FIG. 8 a sequence of applying the anomaly estimation, the out-of-distribution estimation 802, and the accuracy estimation 804 is illustrated. The method in FIG. 8 may be accelerated.

In FIG. 9, a data type classification 900 is performed, for example with a classification or image classification neural network. It can then decide to skip several of the steps and start at either the anomaly estimation 800, the out-of-distribution estimation 802, or the accuracy estimation 804. This may further accelerate the algorithm.

The OOD score (the out-of-distribution score, in-distribution accuracy score, and anomaly estimation score) the can be used for example:
To reject the output of the main model and revert back to non-AI based algorithms
To inform the user of problems in the data and asking for correction, e.g., reacquisition of the data. Possible problems are:
   Faulty components in the imaging device
   Artefacts caused, for example, by motion or metal
   Problems in the processing pipeline
To perform analytics on the imaging device, e.g., predictive maintenance

Examples may be used to estimate whether new input for Deep Learning models (or other trainable machine learning module) is sufficiently similar to the data used for training. If that is not the case (out-of-distribution or OOD), the Deep Learning model can produce wrong, but anatomically plausible, results.

In one example an ensemble of models is trained which is of the same size and network-architecture as the main model. In another example, the models in the ensemble have different architecture from the main model to assure a scalable approach. For example, they can have a lower number of trainable parameters in each layer. For both examples, the OOD Image is computed and the OOD score is computed.

The OOD score can be used to reject the output of the main model and revert to traditional algorithms. In another embodiment it can inform the user of the problems in the input data. In another embodiment it can signal the manufacturer of problems in the imaging device used for processing the images.

An application in the domain MR reconstruction is reconstruction of accelerated scans. The approach may include one or more of the following features:
Acquire the training data
Train a deep learning model to solve the task at hand
Deploy the models to solve a given domain application

After deployment and during routine use of the algorithm on the medical device or software platform:
Acquire the input data
Optional: classify the input data in terms of OOD and decide from which algorithm to start
Compute the OOD score from the anomaly detection algorithm
   if not acceptable reject the input data
   if acceptable continue
Compute the OOD score from the OOD estimation algorithm
   if not acceptable reject the input data
   if acceptable continue
   if no precise accuracy estimation is needed, accept the data and compute the main model
Utilize the OOD score for validating the output of the AI model given the current input.
   If the output data of the main model is classified as OOD given a threshold as defined on the ensemble models by the manufacturer, take actions such as:
Revert to other algorithms that do not suffer from the OOD problem
   For example, for MR reconstruction we can revert to using Compressed SENSE instead of AI-Compressed SENSE.
   Inform the user or the manufacturer of the problem
   Take corrective actions such a rescan for a MR acquisition

In some examples, several algorithms for anomaly/OOD-estimation/Accuracy-estimation can be used.

This invention applies to all medical imaging products using Deep Learning or other machine learning techniques.
Specifically, it can be used to detect “off-label” use of AI processing in medical imaging as e.g. too high noise in CT or PET images, motion patterns of organs an AI software is not trained for, too low sampling in compressed sense AI and many more.
In addition, it can be applied for AI based diagnosis systems which are trained for a limited number of pathologies. Out-of-distribution here means that a pathology is in the image the system has not seen before and therefore, notification is given to the user (radiologist) to evaluate this image w/o relying on the automatic diagnosis. Next to this straightforward application, two more can be derived, namely:
The detection (and alerting) of disease which has not been seen before.
The collection and storage of a new subclass of images from which additional training data sets can be derived for less frequent diseases.

A means of performing OOD detection by statistical characterization of hidden layer neural activation is described below. Out-of-distribution (OOD) detection can be seen as an important step towards failure-mode detection for neural networks, because a neural network cannot be expected to perform well on its task if the input does not lie within the data distribution the network has been trained on. Therefore, from a conservative point of view, it makes sense to exclude such cases in practice. This also makes sense because currently used failure-mode detection methods are computationally very expensive, and one should thus like to limit the application of such costly tests to in-distribution cases.

Examples may provide a very fast method to compute an OOD score that is based on statistical characterization of in-distribution neuron activation. After training the network, inference may be performed on the entire or large portion of the training data, and statistics of neuron activation within the network are recorded. Continuous probability distributions are then fitted to these activation patterns. During inference, the likelihood of the neuron activation observed in the network can then be scored based on these probability distributions. A low score indicates that the neurons' activation is very different to that observed during training, and it can be concluded that the input data is OOD. This is possible because the underlying statistics on in-distribution neuron activation can be seen as a very efficient characterization of the training data distribution itself The main advantage of our technique is that it requires only a single inference pass of the single network, as opposed to more expensive ensemble-based OOD detection methods.

The arrival of modern high-performance graphic processing units (GPUs) has rendered training deep neural networks for difficult tasks a possible and widely available technique. The fact that such neural-network-based algorithms are reaching human or even super-human performance in an increasing number of tasks motivates the current endeavors to deploy them clinically and make them an integral part in the field of medical imaging.

Unrecognized failure mode has been identified as one of the main risks in the clinical deployment of neural networks. For example, if an AI algorithm for image correction (such as denoising or motion artifact reduction) misinterprets part of the noise/artifact as real structure, the output image might have a very natural appearance, but should not be used for diagnosis.

We propose to rate the accuracy of the AI processing by testing quantitatively how similar a given new data set is to the data that were used during training. One particular advantage of the proposed method is that it requires only little computation time.

The distribution of different neurons' activation in the network are recorded after training the network by passing the available data through the network. To judge during inference if the current data set falls within the data distribution used during training, the neurons' activation caused by the current data set is compared to the activation distributions obtained from the training data.

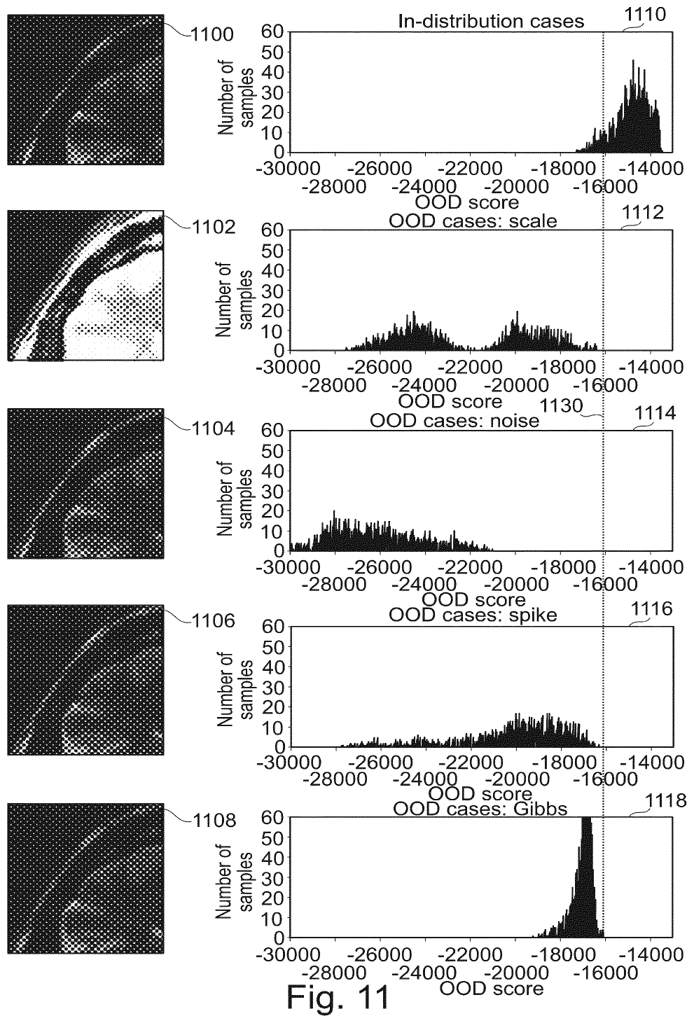

This may for example be implemented by:
Step 1) Train the neural network.
Step 2) Network inference is performed on the entire training, validation, and testing data (these all lie within the training data distribution), while neuron activation in the network is recorded. Neuron activation is broadly defined here as either the output of the neuron's nonlinear activation function, or the input to the nonlinear activation function. Depending on the context, size of the network, available memory, etc., it may be necessary to group neurons in a sensible way and record the average activation of these neuron groups. For example, in an image-to-image convolutional neural network (CNN) or U-net, one could record the average activation in each channel right after the nonlinear activation function in each layer except the final one (see below).
Step 3) Continuous probability distributions (representing, e.g., Gaussian mixture models) are fitted to the observed neuron activation patterns (cf. FIG. 10) and stored. In a more advanced scenario, one may also store information about the covariance/correlation between different neurons' activation.

FIG. 10. shows a first example of the mean activations of a first feature map 1000. Plot 1002 shows a second example of the mean activations for a second feature map 1002. In constructing these graphs, shown are the mean activations of the two feature maps of a motion-correction U-Net for the entire employed training dataset. Both of these empirical distributions are approximated using a Gaussian mixture model 1004. This is the line which is superimposed on the data illustrated in FIG. 10.

When in practice inference is performed on new input data, the likelihood of the neuron activation observed in the network can be scored. In the simplest case this scoring will be based on the stored probability distributions. Adding up the log probabilities obtained from the different probability distributions corresponds to assuming statistical independence of the underlying neuron activation patterns. A low final score indicates that the neurons' activation is very different than in training, and it can be concluded that the input data is OOD. This is possible because the underlying statistics on in-distribution neuron activation can be seen as a very efficient characterization of the training data distribution itself. The data could also come from a peripheral region of the training-data distribution, but since such region will typically be sampled only very sparsely for network training, the risk or network failure will be higher. In a more advanced scenario, covariance/correlation may be taken into account in the OOD scoring.

Examples have been built and tested for both denoising and motion-artifact correction. FIG. 11 shows a possible implementation of the statistical activation pattern analysis: For each feature map in the motion-correction network the mean activation for the training dataset was calculated, and a Gaussian mixture model was fitted to the observed distribution of mean feature activation. This was repeated for all feature maps in the network, yielding a statistical model of the expected “normal” feature activation for in-distribution samples.

To validate this statistical model, OOD samples were simulated by applying several transformations to images from the training dataset:
scaling of image intensity (corresponding, e.g., to incorrect normalization of the data),
increasing the noise level to obtain SNR values much lower than during training,
adding large random values to individual k-space positions, yielding RF-spike-like artifacts,
setting outer parts of k-space to zero, resulting in Gibbs ringing.

FIG. 11 illustrates the usefulness of using the histograms for out-of-distribution detection. FIG. 11 shows examples of these image transformations (amplified for better viewing), as well as the distribution of the resulting OOD scores for n=1252 test images In FIG. 11 there are five input images 1100, 1102, 1104, 1106, 1108. For each of these images there is a corresponding histogram. For image 1100 there is histogram 1110, for image 1102 there is histogram 1112, for image 1104 there is histogram 1114, for image 1106 there is histogram 1116, and for image 1108 there is histogram 1118.

FIG. 11 illustrates the distribution of OOD scores for a motion-correction U-Net. The different histograms show OOD score distributions for n=1252 input images. Image 1100 is within the distribution and image 1110 shows an in-distribution case. The dashed line 1130 is a suggested threshold that can be used when comparing the different histograms to determine if there is out-of-distribution detection. A clear distinction in the calculated OOD scores can be observed, showing that the simulated OOD samples can be well separated from the in-distribution cases. The vertical line indicates 1130 a possible threshold to detect OOD samples—input images with a score below this threshold would be rejected. Image 1102 has the wrong scale. It can be seen that in histogram 1102 the histogram all data is below the threshold 1130. In image 1104 there is a large amount of noise. The histogram 1114 shows noise data which is below the threshold 1130. Image 1106 contains spikes. The histogram 1116 is likewise, below the threshold 1130. Image 1108 has Gibbs ringing artifacts. The histogram 1118 is also below the suggested threshold 1130.

The description above is only one specific way to implement an example. Examples for other embodiments are outlined in the following:
Instead of recording the neurons' activation distribution after training, the activation distribution can be recorded during the final phase of training.
Instead of averaging the activation of a neuron group, other reduction techniques can be applied.
Instead of Step 3, other statistical methods can be employed to quantify how likely the current activations are inside the training-data activation distribution.

Because a neural network cannot be expected to perform well on its task if the input does not lie within the data distribution the network has been trained on, such cases should be excluded in practice. This makes sense also because currently used failure-mode detection methods (e.g., based on model ensembles) are computationally very expensive, and one should thus like to limit the application of such costly tests to in-distribution cases. The main advantage of our technique is that it requires only a single inference pass of the single network, as opposed to more expensive ensemble- or multiple-inference-based methods.

For the design and application of the described examples, additional features can be considered:
In one example, the performance of multiple networks for a given task are estimated using the described OOD score. The most suitable network is then chosen to produce the desired result.
In another example, the described OOD score is calculated repeatedly during an MR acquisition to estimate the final image quality for an image reconstruction network. The acquisition is stopped once the OOD score is below a pre-defined threshold.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### REFERENCE SIGNS LIST

100 medical system
102 computer
104 computational system
106 optional hardware interface
108 optional user interface
110 memory
112 graphical user interface
120 machine executable instructions
122 trainable machine learning module
124 out-of-distribution estimation module
126 in-distribution accuracy estimation module
128 measured medical image data
130 out-of-distribution score
132 in-distribution accuracy score
134 warning signal
136 reconstructed medical image
140 warning
200 receive the measured medical image data
202 determine the out-of-distribution score, the in-distribution accuracy score, and optionally the anomaly estimation score consecutively in an order determined a sequence
204 detect a rejection of the measured medical image data using the out-of-distribution score and/or the in-distribution accuracy score and/or the anomaly estimation score during execution of the sequence
206 provide a warning signal if the rejection of the measured medical image data is detected
208 provide the reconstructed medical image by at least partially inputting the measured medical image data into the trainable machine learning module after completion of the sequence
300 medical system
320 anomaly detection estimation module
322 anomaly estimation score
400 medical system
402 medical imaging system
404 imaging zone
406 subject
408 subject support
420 medical imaging system measurements
500 control the medical imaging system to acquire the measured medical image data
600 training data distribution
800 anomaly estimation
802 ODD estimation
804 Accuracy estimation
806 accept data
808 Reject data (inform the user/rescan/etc.)
900 Data type classification
1000 first example of mean activation of first feature map
1002 second example of mean activation of second feature map
1004 approximation using Gaussian Mixture Model (GMM)
1100 input image
1102 input image
1104 input image
1106 input image
1108 input image
1110 in-distribution histogram
1112 OOD case—wrong scale histogram
1124 OOD case—noise in histogram
1126 OOD case—spike in histogram
1128 OOD case Gibbs in histogram
1130 suggested threshold.

1. A medical system comprising:
a memory configured to store machine executable instructions, wherein the memory further stores a trainable machine learning module trained using training data descriptive of a training data distribution to output a reconstructed medical image in response to receiving measured medical image data as input, wherein the memory further stores an out-of-distribution estimation module configured for outputting an out-of-distribution score in response to receiving the measured medical image data, wherein the out-of-distribution score is descriptive of a probability that the measured medical image is within the training data distribution, wherein the memory further stores an in-distribution accuracy estimation module configured for outputting an in-distribution accuracy score descriptive of a probability that the reconstructed medical image is accurate;
a computational system, wherein execution of the machine executable instructions causes the computational system to:
receive the measured medical image data;
determine the out-of-distribution score and the in-distribution accuracy score consecutively in an order determined a sequence, wherein the out-of-distribution score is determined by inputting the measured medical image data into the out-of-distribution estimation module, wherein the in-distribution accuracy score is determined by inputting the measured medical image data into the in-distribution accuracy estimation module;
detect a rejection of the measured medical image data using the out-of-distribution score and/or the in-distribution accuracy score during execution of the sequence; and
provide a warning signal if the rejection of the measured medical image data is detected.

2. The medical system of claim 1, wherein execution of the machine executable instructions further causes the computational system to provide the reconstructed medical image by at least partially inputting the measured medical image data into the trainable machine learning module after completion of the sequence.

3. The medical system of claim 1, wherein the memory further stores an anomaly detection estimation module configured to output an anomaly estimation score in response to receiving the measured medical image data, wherein the anomaly estimation score is descriptive of a probability that the measured medical image is anomalous in comparison to the training data distribution, wherein execution of the machine executable instructions further causes the computational system to determine the anomaly estimation score consecutively with the out-of-distribution score and the in-distribution accuracy score in the order determined by the sequence, wherein the anomaly estimation score is determined by inputting the measured medical image data into the anomaly detection estimation module, and wherein execution of the machine executable instructions further causes the computational system to detect a rejection of the measured medical image data using the anomaly estimation score during execution of the sequence.

4. The medical system of claim 3, wherein the sequence is predetermined, wherein the measured medical image data is input into the anomaly detection estimation module before the measured medical image data is input into the out-of-distribution estimation module, and wherein the measured medical image data is input into the out-of-distribution estimation module before the measured medical image data is input into the in-distribution accuracy estimation module.

5. The medical system of claim 3, wherein the anomaly detection estimation module comprises at least one of the following:
an autoencoder trained with samples from the training data distribution, wherein the anomaly estimation score is provided as a measure of difference between an input and an output of the autoencoder; or
a density based algorithm configured using predetermined features.

6. The medical system of claim 1, wherein the memory further contains an image classifier neural network trained to determine the sequence in response to receiving the measured medical image data as input, wherein execution of the machine executable instructions further causes the computational system to: determine the sequence by inputting the measured medical image into the image classifier neural network.

7. The medical system of claim 1, wherein the medical system further comprises a medical imaging system, wherein execution of the machine executable instructions further causes the processor to control the medical imaging system to acquire the measured medical image data.

8. The medical system of claim 7, wherein the medical imaging system is at least one of the following: a magnetic resonance imaging system, a computed tomography system, a positron emission tomography system, a single photon emission tomography system, an ultrasound system, an X-ray system, or a digital fluoroscope system.

9. The medical system of claim 1, wherein the warning signal causes at least one of the following:
a reacquisition of the measured medical image data,
a display of the warning signal on a display,
appending metadata descriptive of the warning signal and/or the measured medical image data to the reconstructed medical image, or
abort use of the trainable machine learning module and selecting an alternative reconstruction algorithm to reconstruct the reconstructed medical image.

10. The medical imaging system of claim 1, wherein measured medical image data is formatted in image space, and wherein the trainable machine learning module is formatted as an image processing module.

11. The medical system of claim 1, wherein the measured medical image data comprises at least one of the following:
wherein the measured medical image data comprises medical imaging system measurements; or
wherein the measured medical image data comprises medical imaging system measurements and image space data.

12. The medical system of claim 1, wherein the out-of-distribution estimation module is implemented using at least one of the following:
computing the output of several trained neural networks and compute the variance of the prediction. Rejection is performed if the variance is higher than a given threshold;
a density-based rejection algorithm based on predetermined features to perform out-of-distribution estimation; or
a statistical characterization of hidden layer neural activation.

13. The medical system of claim 1, wherein the trainable machine learning module is configured to output multiple versions of the reconstructed medical image using different random initializations, wherein the in-distribution accuracy score is determined using a statistical comparison between the multiple versions.

14. A computer program comprising machine executable instructions stored on a non-transitory computer readable medium for execution by a computational system controlling a medical system, wherein the computer program further comprises a trainable machine learning module trained using training data descriptive of a training data distribution to output a reconstructed medical image in response to receiving measured medical image data as input, wherein the computer program further comprises an out-of-distribution estimation module configured for outputting an out-of-distribution score in response to receiving the measured medical image data, wherein the out-of-distribution score is descriptive of a probability that the measured medical image is within the training data distribution, wherein the computer program further comprises an in-distribution accuracy estimation module configured for outputting an in-distribution accuracy score descriptive of a probability that the reconstructed medical image is accurate, wherein execution of the machine executable instructions causes the computational system to:
receive the measured medical image data;
determine the out-of-distribution score and the in-distribution accuracy score consecutively in an order determined a sequence, wherein the out-of-distribution score is determined by inputting the measured medical image data into the out-of-distribution estimation module, wherein the in-distribution accuracy score is determined by inputting the measured medical image data into the in-distribution accuracy estimation module;
detect a rejection of the measured medical image data using the out-of-distribution score and/or the in-distribution accuracy score during execution of the sequence; and
provide warning signal if the rejection of the measured medical image data is detected.

15. A method of medical imaging using a trainable machine learning module, an out-of-distribution estimation module, and an in-distribution accuracy estimation module; wherein the trainable machine learning module is trained using training data descriptive of a training data distribution to output a reconstructed medical image in response to receiving measured medical image data as input; wherein the out-of-distribution estimation module is configured for outputting an out-of-distribution score in response to receiving the measured medical image data; wherein the out-of-distribution score is descriptive of a probability that the measured medical image is within the training data distribution;
wherein the in-distribution accuracy estimation module is configured for outputting an in-distribution accuracy score descriptive of a probability that the reconstructed medical image is accurate; wherein the method comprises:
receiving the measured medical image data;
determining an out-of-distribution score and an in-distribution accuracy score consecutively in an order determined a sequence, wherein the out-of-distribution score is determined by inputting the measured medical image data into an out-of-distribution estimation module, wherein the in-distribution accuracy score is determined by inputting the measured medical image data into the in-distribution accuracy estimation module;
detect a rejection of the measured medical image data using the out-of-distribution score and/or the in-distribution accuracy score during execution of the sequence; and
providing a warning signal if the rejection of the measured medical image data is detected.
